(19) United States
(12) Patent Application Publication
(10) Pub. No.: US 2025/0342390 A1
(43) Pub. Date: Nov. 6, 2025

(54) SYSTEMS AND METHODS TO EFFICIENTLY DECREASE THE SIZE OF MACHINE LEARNING AND GENERATIVE AI MODELS

(71) Applicant: SAP SE, Walldorf (DE)

(72) Inventor: Tim Breitenbach, Oberleichtersbach (DE)

(21) Appl. No.: 18/653,677

(22) Filed: May 2, 2024

(51) Int. Cl. G06N 20/00

(52) U.S. Cl. CPC G06N 20/00

(57) ABSTRACT

Described herein are techniques for intelligently pruning a machine learning or generative AI model. The model may first be split up into subunits. Each subunit may be analyzed to calculate a suitable measure such as a stochastic independence score or mutual information score. The subunits may in turn be ranked by their associated score and the lowest ranked subunit or subunits may be pruned from the model. The pruned model is then retrained, and accuracy of the pruned model is evaluated. A determination is then made whether to prune more or to return the pruned model.

### BACKGROUND

Unless otherwise indicated herein, the approaches described in this section are not prior art to the claims in this application and are not admitted to be prior art by inclusion in this section.

A machine learning (ML) model is a program that can find patterns or make decisions from a previously unseen dataset. To do so, the ML model is first trained with a training dataset. Today's ML models have grown quite large in size because of the complexity of the patterns and the today's datasets. As a result, the ML models require more resources and computation time in the target environment. Thus, there is a need to reduce the model size without severely impacting the performance of the model.

### BRIEF DESCRIPTION OF THE DRAWINGS

FIG. 1 illustrates a system for training a ML model according to some embodiments.

FIG. 2 illustrates the model pruning block according to some embodiments.

FIG. 3a illustrates a deep neural network model according to some embodiments.

FIG. 3b illustrates a technique to generate a score for subunits according to some embodiments.

FIG. 3c illustrates a technique to generate a score for subunits according to some embodiments.

FIG. 4 illustrates a technique to generate a score for subunits according to some embodiments.

FIG. 5 illustrates an exemplary workflow for training a ML model according to some embodiments.

FIG. 6 depicts a simplified block diagram of an example computer system, which can be used to implement some of the techniques described in the foregoing disclosure.

### DETAILED DESCRIPTION

Described herein are methods and apparatuses to prune a ML model. While ML models will be described in the examples below, these techniques may also be applied to generative AI models. Each ML model has an architecture that describes how the components of the ML model are interconnected. This can include the structure and organization of the components. In some embodiments, techniques are described to split the architecture of the ML model into subunits and to rank the subunits based on a suitable measure. The suitable measure may be a stochastic independence (SI) score for each subunit. The SI scores may then be ranked and the subunit(s) associated with the lowest SI score(s) may be pruned from the ML model. The pruned ML model may be trained and its performance tested to determine whether the pruned ML model is an acceptable tradeoff between model size and model accuracy. If the tradeoff is acceptable, the pruned ML model that has been trained may be returned. Pruning a ML model may be advantageous because ML models that are smaller in size take up less compute resources to run and also can process data quicker. Therefore, there is a desire to create small, efficient ML models. In other embodiments, a mutual independence (MI) score can be used instead of, or in combination with, the SI score. It is to be understood by those skilled in the art that MI score can be used instead of SI score in any of the embodiments described below. Any other information measure can replace the SI or MI score as well.

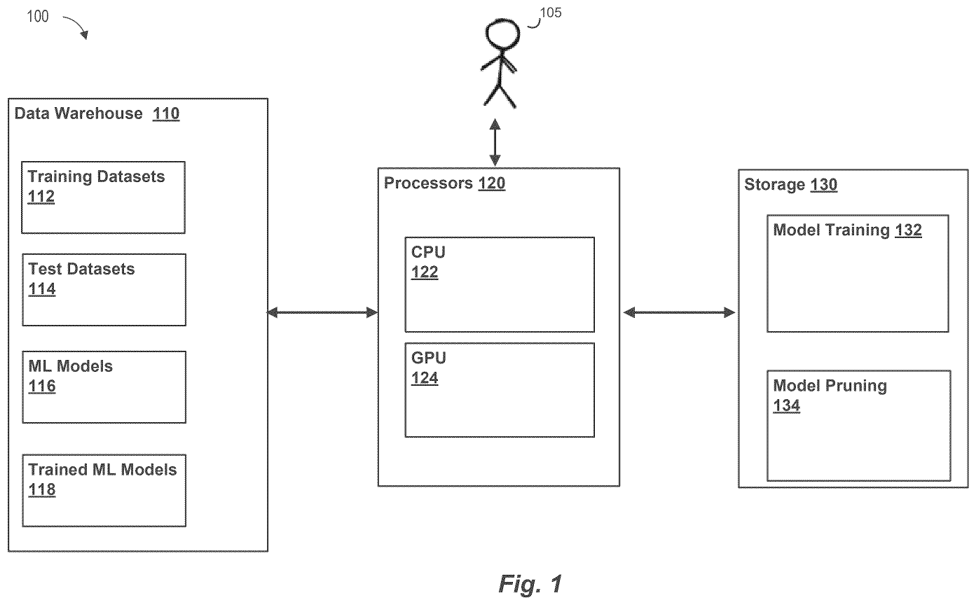

FIG. 1 illustrates a system for training a ML model according to some embodiments. System 100 includes user 105, data warehouse 110, processors 120, and storage 130. Processors 120, which include CPU 122 and GPU 124 are configured to process computer readable instructions from storage 130 to process data and ML models from data warehouse 110.

Data warehouse 110 includes training datasets 112, test datasets 114, ML models 116, and trained ML models 118. Training datasets 112 include datasets which are utilized during training of ML models. Similarly, test datasets 114 include datasets which are utilized during testing of ML models. Each dataset may contain a plurality of entries used for training (or testing) the ML models. Each entry within a dataset includes input variables and output variables. The input variables are input into a ML model and the output variables are the desired output from the ML model. The desired values of the output variables are known as ground truth. In some embodiments, a training dataset may be used in training the ML model and the testing dataset is used to test the trained ML model to determine whether the trained ML model is able to accurately predict the ground truth. If the ML model performs poorly on the test dataset, then the ML model may be retrained. Retraining can include selecting another ML model architecture, changing the hyperparameters of the ML model, and changing the loss function, to name a few. ML models 116 may store ML models that can be selected as a ML architecture to use when training a ML model with a training dataset. Trained ML models can be stored in trained ML models 118.

Storage 130 stores computer readable instructions which, when executed by one or more processors in processors 120, can train a ML model. Training can include pruning to simplify the ML model so to improve speed and size. The computer readable instructions can include model training 132 which trains a ML model and model pruning 134. Each component shown here can be a block of software code which can be executed by CPU 122 or GPU 124. In one embodiment, model pruning 134 can contain computer code to evaluate whether a trained ML model trained by model training 132 can be simplified through pruning (i.e. removing) portions of the trained ML model.

Here, user 105 may provide instructions to processors 120 to train a ML model. In one example, user 105 may define the ML model to use, the training dataset to use, and configure the ML model. Processor 120 may retrieve computer readable instructions from storage 130 to train the ML model, which can include model training 132. Processors 120 may also retrieve the desired training dataset and ML model from data warehouse 110 and execute computer readable code from storage 130 to train the ML model. Processors 120 may also execute computer readable code from storage 130 to prune the trained ML model.

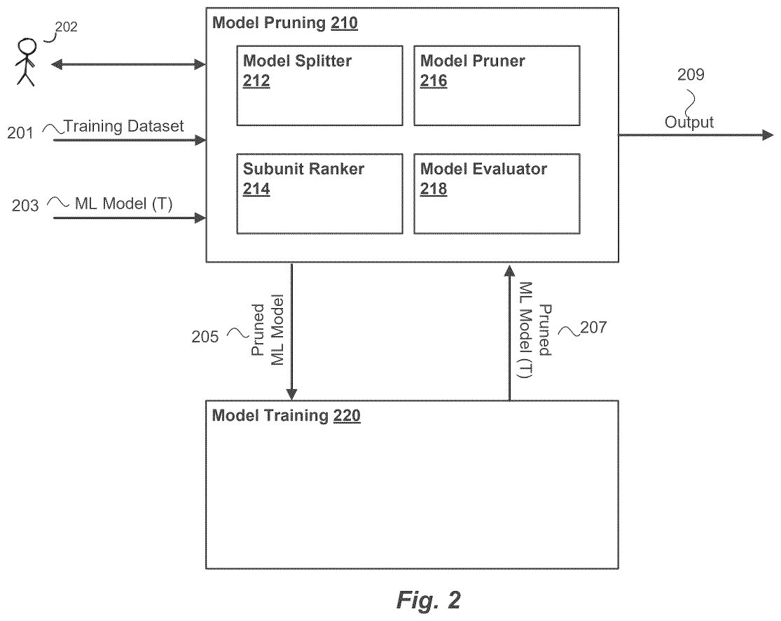

FIG. 2 illustrates the model pruning block according to some embodiments. Model pruning block 210 represents a block of software code that can be executed by processors 120 in FIG. 1. The block of software code is configured to prune a ML model 203 that has been trained with training dataset 201. Training dataset 201 can also be a test dataset, validation dataset, or other dataset, depending on implementation details. Output 209 of model pruning block 210 is the trained ML model 203 if pruning was unsuccessful and is a pruned ML model that has been trained with training dataset 201 if pruning was successful.

Model pruning block 210 includes model splitter 212, subunit ranker 214, model pruner 216, and model evaluator 218. Model splitter 212 is configured to split the trained ML model 203 into a plurality of subunits. In one embodiment, the manner in which model splitter 212 splits the ML model may depend on the architecture of the model. For example, a deep neural network may be split according to the layers where each layer is a subunit. As another example an attention model may be split according to the attention modules where each attention module is a subunit. In another embodiment, the manner in which model splitter splits the ML model may be defined by user 202. For example, model splitter 212 may graphically present the architecture of ML model 203 to user 202 and may receive instructions from user 202 on how to split ML model 203 into subunits.

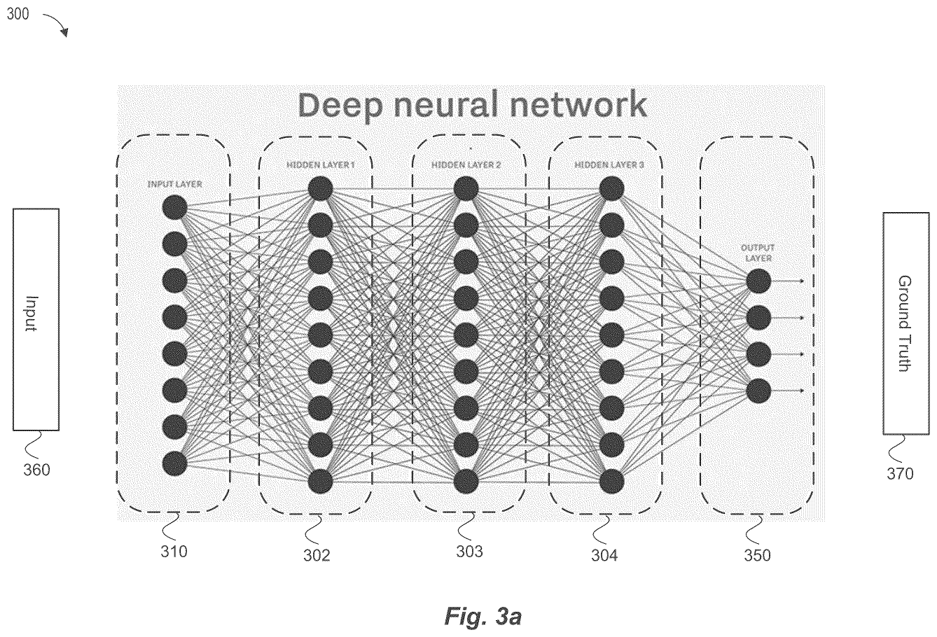

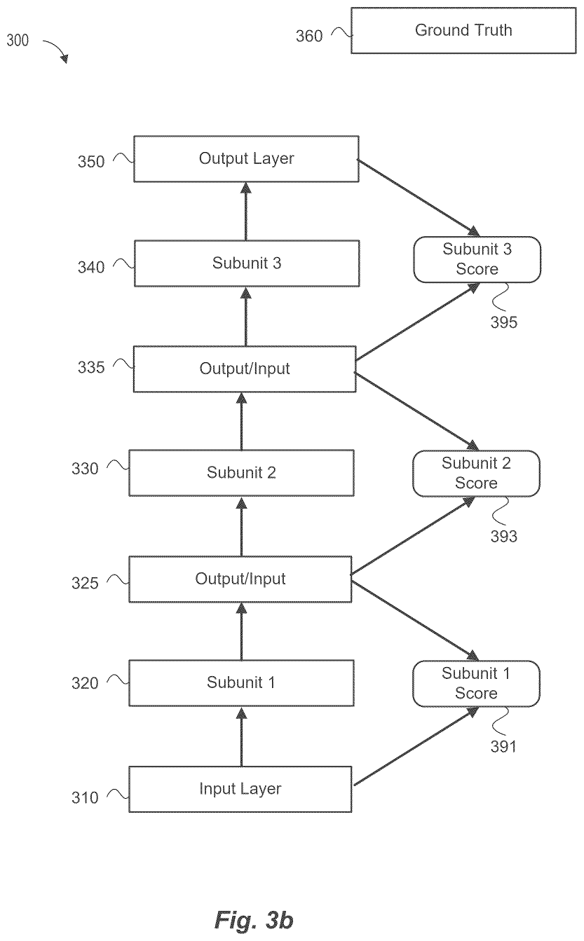

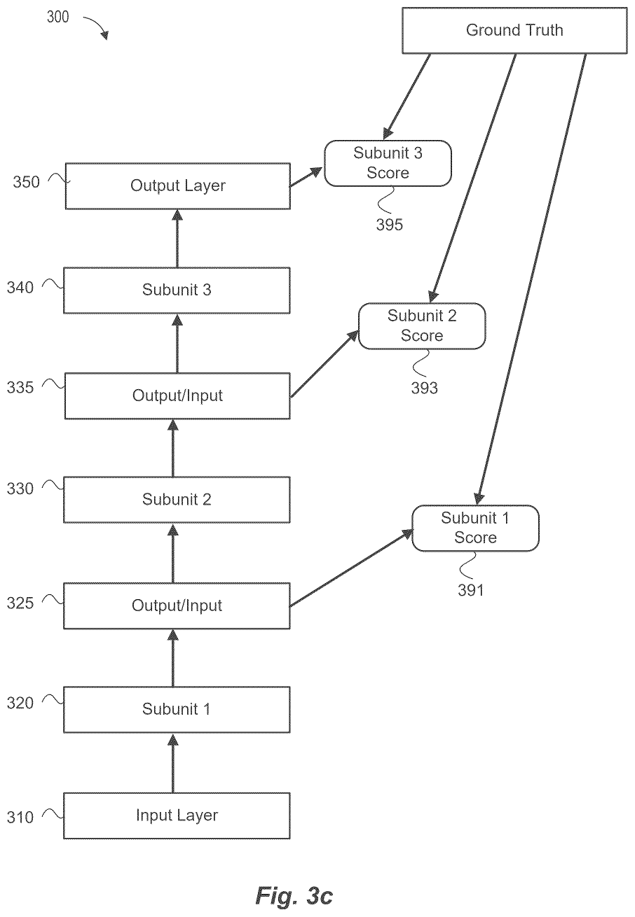

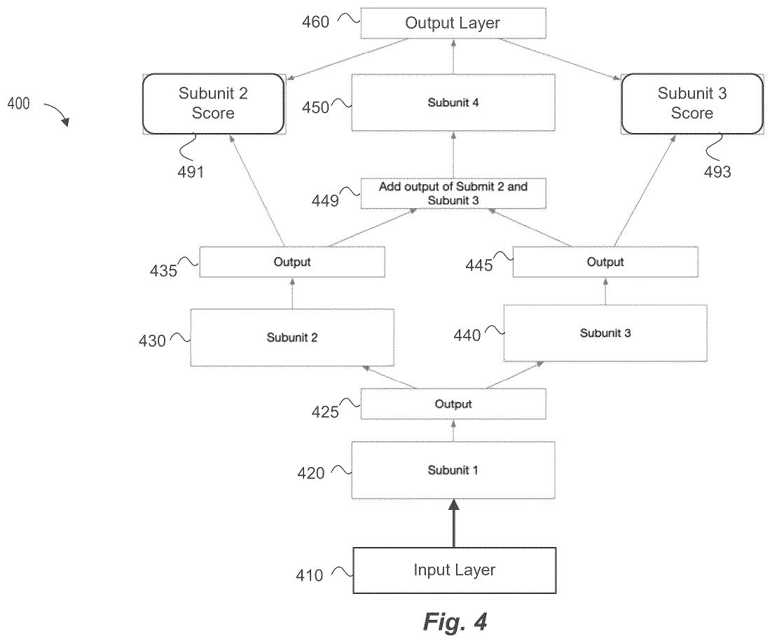

Subunit ranker 214 is configured to rank the subunits. In one embodiment, subunit ranker 214 may generate a score for each subunit and rank the subunits according to their score. In one embodiment, the score may be a stochastic independence (SI) score. A SI score may measure the stochastic dependence of two variables, or whether the two variables take their values independent of each other. For example, an SI score calculated from the input and output of a subunit would measure whether there is dependence between the input and output of the subunit. A high SI score would mean that the two variables are independent of one another while a low SI score would mean that the two variables are dependent on one another. Alternatively, a high score can signify dependence while a low score can signify independence. In another embodiment, the score may be a mutual information (MI) score. A MI score may measure the mutual information between two variables, meaning how much there is known to infer the value of one variable given the value of the other variable. A high MI score would mean that the two variables are highly dependent on one another. Similarly, a low MI score would mean that the two variables are not very dependent on one another and take their values stochastically independent of each other. Exemplary embodiments on how to generate the score are described further in FIGS. 3b, 3c, and 4.

Model pruner 216 is configured to prune ML model 203. Model pruner 216 may select subunits to prune according to their corresponding score that was generated by subunit ranker 214. Pruning may involve removing the pruned subunits from the ML model and optionally generating new connections for the remaining subunits in the ML model. Model pruner 216 may generate pruned ML model 205 which in turn is transmitted to model training 220 to be trained with training dataset 201. In some embodiments, the number of subunits to prune may be dependent on parameters set in model pruning 210. In one example, a parameter may define a threshold of at least 20% of the ML model to be pruned. Model pruner 216 may in response prune the lowest scoring subunits until the ML model has reduced in size by 20%. In another example, a parameter may define a threshold of at least 70% accuracy of the pruned ML model when compared to the non-pruned ML model. Model pruner 216 may in response iteratively prune the lowest scoring subunits until the ML model falls below an accuracy score of 70% and then reverse the last subunit pruned so that the performance is above the 70% threshold. In yet other examples, other parameters may be defined to dictate how much of the ML model should be pruned.

Model Evaluator 218 is configured to evaluate the pruned ML model. Model evaluator 218 may evaluate the pruned ML model based on the parameters set in model pruning 210. In one embodiment, model training 220 may receive pruned ML model 207 and train the ML model to generate pruned, trained ML model 207. The pruned, trained ML model 207 may be received by model evaluator 218 to evaluate the performance or accuracy of the model to determine whether the trained, pruned ML model satisfies the parameters set forth. If trained, pruned ML model 207 satisfies the parameters set forth, then model pruning 210 may output trained, pruned ML model 207 as output 209. However, if the trained, pruned ML model does not satisfy the parameters, then nothing may be output or the trained ML model 203 may be returned instead.

In some embodiments, model evaluator 218 may also analyze pruned subunit(s) when the accuracy or performance of the pruned model is below a desired threshold. Analysis can include analyzing where information is lost in the pruned subunit(s). For instance, in a model consisting of a cascade of layers such as the model shown in FIG. 3b, pruning an early subunit such as subunit 1 may have an impact on downstream subunits 2 and 3. In one embodiment, model pruning 210 may attempt to retrain the pruned subunit and return the pruned subunit that has been retrained to the model where it was originally. For instance, a retrained subunit 1 may be returned to the model shown in FIG. 3b. In another embodiment, model pruning 210 may generate or retrieve an alternative subunit and add the alternative subunit to the model where the pruned subunit was originally. This may be an opportunity to replace a poorly performing subunit with another. In both instances, the model may be retrained and pruning may be attempted once more.

FIG. 3a illustrates a deep neural network model according to some embodiments. As shown deep neural network (DNN) model 300 includes layers 310, 302, 303, 304, and 350. Layer 310 is an input layer which is where input variables are fed into DNN model 300. Layer 350 is an output layer which is the output of DNN model 300. Layer 350 may include a plurality of output variables. As shown, the number of input variables does not have to be the same as the number of output variables. Here, there are more input variables than output variables. Layers 302, 303 and 304 are hidden layers in DNN model 300. In one embodiment, model splitter 212 of FIG. 2 may split DNN model 300 at each hidden layer. In one example this decision to split DNN model 300 by hidden layers may be a manual decision specified by a user. In another example this decision to split DNN model 300 by hidden layers may be an automated decision made by model splitter 212 based on the architecture of DNN model 300. Thus, each hidden layer may become a subunit of DNN model 300 and subsequently ranked for purposes of pruning. DNN model 300 may be trained by a training dataset that includes input data 360 and output data 370. Input data 360 may be fed into layer 310, which then propagates through hidden layers 302, 303, and 304, until predicted output is generated at layer 350. The predicted output can be compared with output data 370 to determine how accurate DNN model 300 is in its predictions. Since the predicted output is compared with output data 370, output data 370 is also known as the ground truth.

FIG. 3b illustrates a technique to generate a score for subunits according to some embodiments. In one embodiment, the score may be generated by subunit ranker 214 in FIG. 2. DNN model 300 has been split into a plurality of subunits, each subunit corresponding to a hidden layer of DNN model 300. For example, subunit 1 320 corresponds to hidden layer 302, subunit 2 330 corresponds to hidden layer 303, and subunit 3 340 corresponds to hidden layer 304. As shown here, subunit score 1 391 is generated by calculating a stochastic independence score that measures the stochastic dependence between the input of the subunit and the output of the subunit. If the input and output of the subunit are independent of one another, then the SI score is high meaning that the subunit does not contribute much to predicting the ground truth and therefore is a candidate for removal. For example if f(x)=y is the function that represents the subunit, then x and y are usually dependent on one another because y is a function of x. Since there is dependency, removing the subunit may result in information loss. As another example, if y=f(x) is the function that represents the subunit and the function is a constant function that is constantly mapping all of x to the same value, then there is little mutual information since changes in x do not affect the value of y. Since y and x are independent, removing the subunit may not result in information loss. A value such as an SI value may be generated for each subunit and one or more subunits may subsequently be pruned according to their SI scores. Subunit score 2 393 may be generated for subunit 2 330 and subunit score 3 395 may be generated for subunit 3 340.

FIG. 3c illustrates a technique to generate a score for subunits according to some embodiments. In one embodiment, the score may be generated by subunit ranker 214 in FIG. 2. DNN model 300 has been split into a plurality of subunits, each subunit corresponding to a hidden layer of DNN model 300. For example, subunit 1 320 corresponds to hidden layer 302, subunit 2 330 corresponds to hidden layer 303, and subunit 3 340 corresponds to hidden layer 304. As shown here, subunit score 1 392 is generated by calculating a SI score that measures the stochastic dependence between the output 325 of subunit 1 320 and the ground truth 370. Similarly, subunit score 2 394 is generated by calculating a SI score that measures the stochastic dependence between output 335 and ground truth 370. Lastly subunit score 3 396 is generated by calculating a SI score that measures the stochastic dependence between output layer 350 and ground truth 370. The ground truth may be used here instead of deviations from the model prediction so that the score represents the information content of some output/vector representation/embedding for predicting the ground truth. An output that is stochastically dependent on the ground truth should likely not be deleted. Similarly, an output that is stochastically independent of the ground truth. Measuring the stochastic dependence between the output of a subunit and the ground truth may be meaningful to determine how dependent the ground truth is to the output of the subunit. Subunits generating an output that is stochastically dependent to the ground truth may have a low SI score and therefore is a bad candidate for pruning. Subunits generating an output that is stochastically independent to the ground truth may have a high SI score and therefore is a good candidate for pruning.

FIG. 4 illustrates a technique to generate a score for subunits according to some embodiments. In one embodiment, the score may be generated by subunit ranker 214 in FIG. 2. Model 400 includes input 410. Input 410 is input into subunit 1 420 which generates output 425. Output 425 is provided as input into subunit 2 430 and subunit 3 440. Subunit 2 430 generates output 435 and subunit 3 440 generates output 445. Outputs 435 and 445 are then combined together to form output 449 which is then fed into subunit 4 450. Subunit 450 generates output 460. As shown here, there are two branches to the data flow through model 400-through subunit 2 430 and through subunit 3 440. Pruning may involve removing one of these branches. In one embodiment, mutual information can be calculated for each branch to determine which branch contributes least to the output 460 of subunit 4 450. The branch that contributes least to the output can be a candidate for pruning. If there are multiple branches, the branches may be ranked and pruned until a predefined condition is met, for example a desired accuracy score. For example, subunit 2 score 491 can be generated by measuring the mutual information between output 435 and output of subunit 4 460. Similarly, subunit 3 score 493 can be generated by calculating the mutual information before between output 445 and output of subunit 4 460. In another embodiment, score 491 may be generated by measuring the mutual information between output 435 and ground truth instead of the output of subunit 4 460. Similarly, score 493 may be generated by measuring the mutual information between output 445 and ground truth instead of the output of subunit 4 460. The mutual information may measure a MI score that represents the mutual dependence between two variables. A high MI score for subunit 2 score 491 would mean that the two variables (output of subunit 2 and the output of upstream subunit 4) are highly dependent on one another. In other words, the output 435 has a high impact on output 460. Similarly, a low MI score for subunit 3 score 493 would mean that the two variables (output of subunit 3 and the output of upstream subunit 4) are very independent of one another. In other words, the output 445 has a low impact on output 460. If subunit score 2 491 has a high MI score and subunit score 3 493 has a low MI score, then subunit 3 440 may be a better candidate for pruning than subunit 2 430 since pruning subunit 3 440 would have a lower impact on the output 460 of subunit 4 450. Instead of output of Subunit 4, the ground truth can be taken.

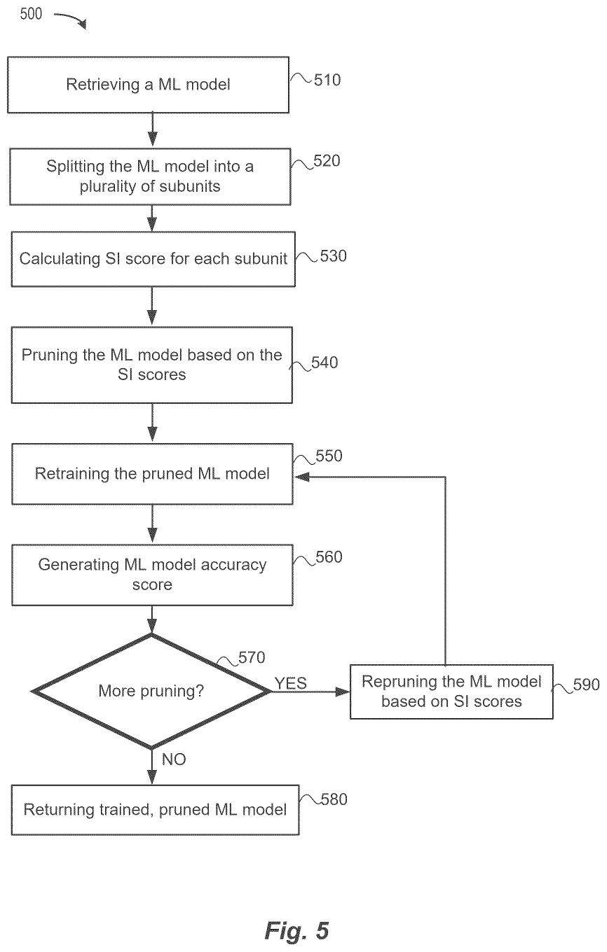

FIG. 5 illustrates an exemplary workflow for training a ML model according to some embodiments. Workflow 500 can be implemented as computer readable code that is stored in model pruning 210 of FIG. 2, the code being executable by one or more processors from processors 120 of FIG. 1. Workflow 400 can begin by receiving a ML model at 510. The ML model may have a ML architecture and a ML configuration. The ML model may have previously been trained with a training dataset. The training dataset may be a dataset from a data warehouse 110 in FIG. 1. Depending on the implementation, the dataset can be any dataset that the user plans on using to train a ML model. Workflow 500 continues by splitting the ML model into a plurality of subunits at step 520. In one embodiment, the ML model may be split according to the ML architecture. For example, a first ML architecture may dictate splitting the ML model in a first manner while a second ML architecture may dictate splitting the ML model in a second manner. In another embodiment, the ML model may be split according to instructions provided by the user. For example, a user such as an AI architect may review the architecture of the ML model and define how to split the ML model into subunits.

Once the ML model has been split, workflow 500 continues by calculating an SI score for each subunit at 530. Depending on implementation details, the SI score may be calculated between the output of the subunit and the input, the output of the subunit and the ground truth, the output of the subunit and the output of another subunit further upstream, or other methods that involve evaluating the stochastic dependence of subunit input, subunit out, input data, and ground truth. The manner in which the SI score is calculated may be specified by the user or alternatively may be automatically selected by the software. For example, the software may analyze the manner in which the subunits are interconnected and select a method for calculating the SI score. In some embodiments, a MI score may be calculated instead of a SI score. In other embodiments, an SI score and an MI score can both be calculated, and a combined weighted score can be generated based on the SI score and the MI score.

Workflow 500 then continues by pruning the ML model based on the SI scores at 540. In one embodiment, the subunit with the lowest SI score may be pruned from the ML model. In another embodiment, the pruning criteria may specify a predetermined reduction in model size (for example, 20% or 0.01%) and one or more subunits with the lowest SI score may be pruned to satisfy the pruning criteria. Pruning may involve removing the subunit from the ML model and reconnecting subunits that were impacted by the removed subunit. For example, if subunit 2 330 of FIG. 3b were pruned, then output of subunit 1 320 would be used as input to subunit 3 340. Once the ML model has been pruned, workflow 500 continues by retraining the pruned ML model at 550. In one embodiment, retraining may involve applying the same parameters as the ML model prior to pruning. In other words, the pruned ML model may be seeded with the same parameters as the unpruned ML model. In another embodiment, randomly initiated parameters may be utilized in the retraining.

Workflow 500 then continues by generating a ML accuracy score at 560. The ML accuracy score measures the performance of the pruned, trained ML model. In one embodiment, the training dataset used to train the original ML model may be applied to the pruned, trained ML model to determine how accurate the predictions generated by the model are to the ground truth. The accuracy can be represented as an accuracy score. Workflow 500 continues by determining whether more pruning should be performed at 570. In one embodiment, the determination may include comparing the accuracy score of the trained, pruned model and the accuracy score of the model prior to pruning. For example, if the accuracy score of the pruned model is within a predetermined percentage of the accuracy score of the model prior to pruning, then more pruning may be performed. In another embodiment, the determination may include evaluating the accuracy score of the trained, pruned model. For example, if the accuracy score is above a certain threshold (e.g., above 90% accuracy), then more pruning can be performed. However, if the accuracy is between another threshold (e.g., 80-90% accuracy), then no more pruning should be performed in fear of the accuracy of the model being too low. In yet other embodiments, other techniques may be applied to analyze the accuracy score of the trained, pruned model. If no more pruning should be performed, workflow 500 continues by returning the trained, pruned ML model at 580. Alternatively, if more pruning should be performed, workflow 500 continues by repruning the ML model based on the SI scores at 590. The repruned ML model can in turn be retrained at 550 and a new ML model accuracy score can be generated at 560. This process can be iteratively performed until the ML model has been pruned to the desired criteria. Possible criteria include desired model size, desired accuracy score, or a combination of the two (e.g., a desired model size that up to 30% smaller while maintaining an accuracy score of at least 80% accuracy). In other embodiments if more pruning is required, workflow 500 can return to step 520 where the pruned ML model is split into subunits again (the subunits generated this time may be different than the subunits generated during the first iteration), calculating the SI scores for each subunit at 530, pruning the ML model a second time at 540, retraining the pruned model at 550, and generating a new ML model accuracy score at 560.

In other embodiments, a measure for self-similarity, like the Pearson correlation coefficient, can be utilized to identify subunits that only direct information through and thus are close to an identity. Subunits close to identify can be candidates receive a low score and thus are candidates for pruning.

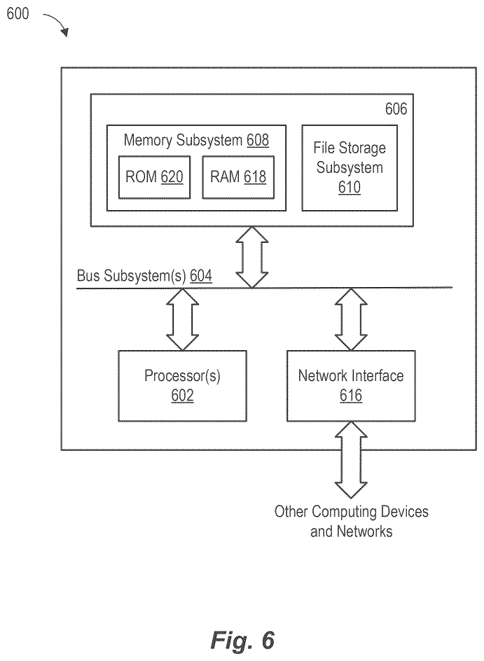

FIG. 6 depicts a simplified block diagram of an example computer system, which can be used to implement some of the techniques described in the foregoing disclosure. As shown in FIG. 6, system 600 includes one or more processors 602 that communicate with several devices via one or more bus subsystems 604. These devices may include a storage subsystem 606 (e.g., comprising a memory subsystem 608 and a file storage subsystem 610) and a network interface subsystem 616. Some systems may further include user interface input devices and/or user interface output devices (not shown).

Bus subsystem 604 can provide a mechanism for letting the various components and subsystems of system 600 communicate with each other as intended. Although bus subsystem 604 is shown schematically as a single bus, alternative embodiments of the bus subsystem can utilize multiple buses.

Network interface subsystem 616 can serve as an interface for communicating data between system 600 and other computer systems or networks. Embodiments of network interface subsystem 616 can include, e.g., Ethernet, a Wi-Fi and/or cellular adapter, a modem (telephone, satellite, cable, etc.), and/or the like.

Storage subsystem 606 includes a memory subsystem 608 and a file/disk storage subsystem 610. Subsystems 608 and 610 as well as other memories described herein are examples of non-transitory computer-readable storage media that can store executable program code and/or data that provide the functionality of embodiments of the present disclosure.

Memory subsystem 608 comprise one or more memories including a main random access memory (RAM) 618 for storage of instructions and data during program execution and a read-only memory (ROM) 620 in which fixed instructions are stored. File storage subsystem 610 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 600 is illustrative and many other configurations having more or fewer components than system 600 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method, comprising: receiving a machine learning (ML) model having an architecture and a configuration, the machine learning model having been previously trained with a training dataset; splitting the ML model into a plurality of subunits; calculating a stochastic independence (SI) score for each of the plurality of subunits; and pruning at least one of plurality of subunits from the ML model based on the SI score to create a pruned ML model.

In one embodiment, the method further comprises training the pruned ML model with the training dataset; generating an accuracy score by applying the training dataset to the trained, pruned ML model; and returning the trained, pruned ML model when the accuracy score is above a predefined threshold.

In one embodiment, training the pruned ML model includes copying the configuration from the ML model to the pruned ML model.

In one embodiment, the method further comprises training the pruned ML model with the training dataset; generating an accuracy score by applying the training dataset to the trained, pruned ML model; and determining that the accuracy score is below a predefined threshold; and analyzing the at least one pruned subunit in response to the determination.

In one embodiment, the SI score is based on input variables of the subunit and output variables of the subunit when the training dataset is applied to the ML model.

In one embodiment, the SI score is based on output variables of a subunit and a ground truth of the training dataset when the training dataset is applied to the ML model.

In one embodiment, the SI score is based on calculating the stochastic independence based on output variables of a first subunit and output variables of a second subunit upstream from the first subunit.

In some embodiments, a system comprises one or more processors; a non-transitory computer-readable medium storing a program executable by the one or more processors, the program comprising sets of instructions for: receiving a machine learning (ML) model having an architecture and a configuration, the machine learning model having been previously trained with a training dataset; splitting the ML model into a plurality of subunits; calculating a stochastic independence (SI) score for each of the plurality of subunits; and pruning at least one of plurality of subunits from the ML model based on the SI score to create a pruned ML model.

In some embodiments, a non-transitory computer-readable medium stores a program executable by one or more processors, the program comprising sets of instructions for receiving a machine learning (ML) model having an architecture and a configuration, the machine learning model having been previously trained with a training dataset; splitting the ML model into a plurality of subunits; calculating a stochastic independence (SI) score for each of the plurality of subunits; and pruning at least one of plurality of subunits from the ML model based on the SI score to create a pruned ML model.

What is claimed is:

1. A method, comprising:
receiving a machine learning (ML) model having an architecture and a configuration, the machine learning model having been previously trained with a training dataset;
splitting the ML model into a plurality of subunits;
calculating a stochastic independence (SI) score for each of the plurality of subunits; and
pruning at least one of plurality of subunits from the ML model based on the SI score to create a pruned ML model.

2. The method as in claim 1, further comprising:
training the pruned ML model with the training dataset;
generating an accuracy score by applying the training dataset to the trained, pruned ML model; and
returning the trained, pruned ML model when the accuracy score is above a predefined threshold.

3. The method as in claim 2, wherein training the pruned ML model includes copying the configuration from the ML model to the pruned ML model.

4. The method as in claim 1, further comprising:
training the pruned ML model with the training dataset;
generating an accuracy score by applying the training dataset to the trained, pruned ML model;
determining that the accuracy score is below a predefined threshold; and
analyzing at least one pruned subunit in response to the determination.

5. The method as in claim 1, wherein the SI score is based on input variables of the subunit and output variables of the subunit when the training dataset is applied to the ML model.

6. The method as in claim 1, wherein the SI score is based on output variables of a subunit and a ground truth of the training dataset when the training dataset is applied to the ML model.

7. The method as in claim 1, wherein the SI score is based on calculating the stochastic independence based on output variables of a first subunit and output variables of a second subunit upstream from the first subunit.

8. A system comprising:
one or more processors;
a non-transitory computer-readable medium storing a program executable by the one or more processors, the program comprising sets of instructions for:
receiving a machine learning (ML) model having an architecture and a configuration, the machine learning model having been previously trained with a training dataset;
splitting the ML model into a plurality of subunits;
calculating a stochastic independence (SI) score for each of the plurality of subunits; and
pruning at least one of plurality of subunits from the ML model based on the SI score to create a pruned ML model.

9. The system of claim 8, wherein the program further comprises sets of instructions for:
training the pruned ML model with the training dataset;
generating an accuracy score by applying the training dataset to the trained, pruned ML model; and
returning the trained, pruned ML model when the accuracy score is above a predefined threshold.

10. The system of claim 9, wherein training the pruned ML model includes copying the configuration from the ML model to the pruned ML model.

11. The system of claim 8, wherein the program further comprises sets of instructions for:
training the pruned ML model with the training dataset;
generating an accuracy score by applying the training dataset to the trained, pruned ML model;
determining that the accuracy score is below a predefined threshold; and
analyzing the at least one pruned subunit in response to the determination.

12. The system of claim 8, wherein the SI score is based on input variables of the subunit and output variables of the subunit when the training dataset is applied to the ML model.

13. The system of claim 8, wherein the SI score is based on output variables of a subunit and a ground truth of the training dataset when the training dataset is applied to the ML model.

14. The system of claim 8, wherein the SI score is based on calculating the stochastic independence based on output variables of a first subunit and output variables of a second subunit upstream from the first subunit.

15. A non-transitory computer-readable medium storing a program executable by one or more processors, the program comprising sets of instructions for:
receiving a machine learning (ML) model having an architecture and a configuration, the machine learning model having been previously trained with a training dataset;
splitting the ML model into a plurality of subunits;
calculating a stochastic independence (SI) score for each of the plurality of subunits; and
pruning at least one of plurality of subunits from the ML model based on the SI score to create a pruned ML model.

16. The non-transitory computer-readable medium of claim 15, the program further comprising sets of instructions for:
training the pruned ML model with the training dataset;
generating an accuracy score by applying the training dataset to the trained, pruned ML model; and
returning the trained, pruned ML model when the accuracy score is above a predefined threshold.

17. The non-transitory computer-readable medium of claim 16, wherein training the pruned ML model includes copying the configuration from the ML model to the pruned ML model.

18. The non-transitory computer-readable medium of claim 16, the program further comprising sets of instructions for:
training the pruned ML model with the training dataset;
generating an accuracy score by applying the training dataset to the trained, pruned ML model;
determining that the accuracy score is below a predefined threshold; and
analyzing the at least one pruned subunit in response to the determination.

19. The non-transitory computer-readable medium of claim 16, wherein the SI score is based on output variables of a subunit and a ground truth of the training dataset when the training dataset is applied to the ML model.

20. The non-transitory computer-readable medium of claim 16, wherein the SI score is based on calculating the stochastic independence based on output variables of a first subunit and output variables of a second subunit upstream from the first subunit.
